(19) United States
(12) Patent Application Publication
(10) Pub. No.: US 2007/0168507 A1
(43) Pub. Date: Jul. 19, 2007

(54) Resource arbitration via persistent reservation

(75) Inventors: Rajsekhar Das, Kirkland, WA (US); Norbert Paul Kusters, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/273,866

(22) Filed: Nov. 15, 2005

(51) Int. Cl. G06F 15/173

(52) U.S. Cl. 709/225

(57) ABSTRACT

Reserving ownership of a shared resource including registering a node with the shared resource using a first registration, delaying an interval of time and then attempting to detect the registration and, if the first registration is detected indicating no other node is maintaining ownership of the shared resource, preempting any pre-existing reservation placing a new reservation for the node with the shared resource, the new reservation limiting any other node from reserving ownership of the shared resource.

### BACKGROUND

Distributed computing systems generally allow multiple computing nodes to access various shared resources. Some such shared resources may only be “owned” by a single node at a time. Such ownership may allow access, usage, control, and/or management. A distributed computing system may be described as a collection of networked computing devices and other shared resources that can communicate with each other. Shared resources may include printers, storage devices, displays, communications devices, etc.

One example of such a distributed computing system is a cluster computing system including a storage area network that allows multiple nodes to access an array of shared storage devices. While such systems provide the benefit of fault-tolerant operation, such a system can experience problems when the disks are improperly accessed. For example, simultaneous read and write accesses by different nodes may corrupt a disk's data, potentially leading to serious consequences.

### SUMMARY

The following presents a simplified summary of the disclosure in order to provide a basic understanding to the reader. This summary is not an extensive overview of the disclosure and it does not identify key or critical elements of the technology or delineate the scope of the technology. Its sole purpose is to present some of the concepts disclosed herein in a simplified form as a prelude to the more detailed description that is presented later.

The present examples provide various technologies for enabling a node to establish ownership of a shared resource. These technologies include registering a node with the shared resource and attempting to reserve ownership of the shared resource. If the node is unable to reserve ownership of the shared resource, the technology includes detecting a pre-existing reservation with the shared resource and attempting to preempt the preexisting reservation by placing a new reservation for the node with the shared resource. This new reservation limits any other node from reserving ownership of the shared resource so long as the node properly maintains its ownership of the shared resource.

Such technologies may be important when, for example, a disk serves as a shared cluster device or resource. Because multiple nodes in a cluster tend to access shared disks, there is the possibility of inappropriate access and data corruption. A cluster generally cannot tolerate data corruption on a cluster device resulting from inappropriate access by cluster nodes.

### DESCRIPTION OF THE DRAWINGS

FIG. 1 is block diagram showing a distributed computing system including several nodes and shared storage devices couple by a network.

FIG. 2 is a block diagram showing one example of an ownership reservation process that a node may use to reserve ownership of a shared resource.

FIG. 3 is a block diagram showing one example of an ownership maintenance process that a node may use to maintain ownership of a currently owned shared resource.

FIG. 4 is a timing diagram showing an example sequence for reserving and maintaining ownership of a shared resource.

FIG. 5 is a timing diagram showing an example sequence for reserving and maintaining ownership of a shared resource when the node previously owning the shared resource fails.

FIG. 6 is a timing diagram showing an example sequence for reserving and maintaining ownership of a shared resource after communications between nodes fails.

FIG. 7 is a block diagram showing a distributed computing system including a node with multiple device interfaces.

FIG. 8 is a block diagram showing an example computing environment in which the technology described above may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

Although the present examples are described and illustrated as being implemented in a distributed computing system, the methods and systems described are provided as examples and not limitations. The present examples are suitable for application in a variety of different types of systems.

One solution to the problem of protecting a shared resource from inappropriate access is to establish ownership of the resource by one node at a time. In the case of a shared storage device, this ownership may provide exclusive access, or it may provide exclusive write access while allowing other nodes to read from the device, etc. Access may be provided to the entire device or to various partitions or sections of the device. In a clustering system, a shared storage device generally maintains data and state information for the cluster and, so long as one of the nodes of the cluster can access this data, the cluster tends to remain operational.

In the interest of increased reliability it may be desirable for a cluster to maintain a set of shared storage devices, each device of the set typically including a replica of cluster data and state information. In this case, one of the nodes in the cluster will generally maintain ownership of the set of replicas. In the event of failure of less than a majority of the members of a replica set, the cluster generally remains operational. A properly functioning majority of replica members owned by a node is known as a quorum.

In clustering and distributed computing systems, problems sometimes arise when member nodes lose their ability to communicate with one another. Such communication failures may occur due to node failure, failure of network links, a device crash, power failure, etc. Given such a failure, a cluster generally attempts to continue operation if at all possible. As a result, nodes that are still operational tend to group themselves with other operational nodes with which they can communicate. There may be multiple groups of one or more nodes that are unable to communicate with any other groups of nodes and yet may be able to communicate with one or more of the shared resources, such as shared storage devices. One of the nodes in each such group may be selected to attempt to take ownership of the shared storage devices forming a quorum. An ownership arbitration process may be used to establish a quorum such that a single node obtains ownership of a replica set.

Reasons for using a clustering system generally include providing a service with the highest possible uptime (availability), the lowest possible failure rate (reliability) and the ability to add system resources to improve service performance (scalability). Another important aspect of cluster-based services tends to be performance: a service should provide as little operational and response delay as possible.

One performance consideration may be the amount of delay introduced when shared disk ownership moves from one node to another. The technology used to detect whether a current owner is operational or to change ownership may introduce delay in the operation of a system. The present example provides technologies for detecting and changing ownership of a shared resource while minimizing delay in the operation of the system. These technologies may be applied to other types of shared resources and devices as well.

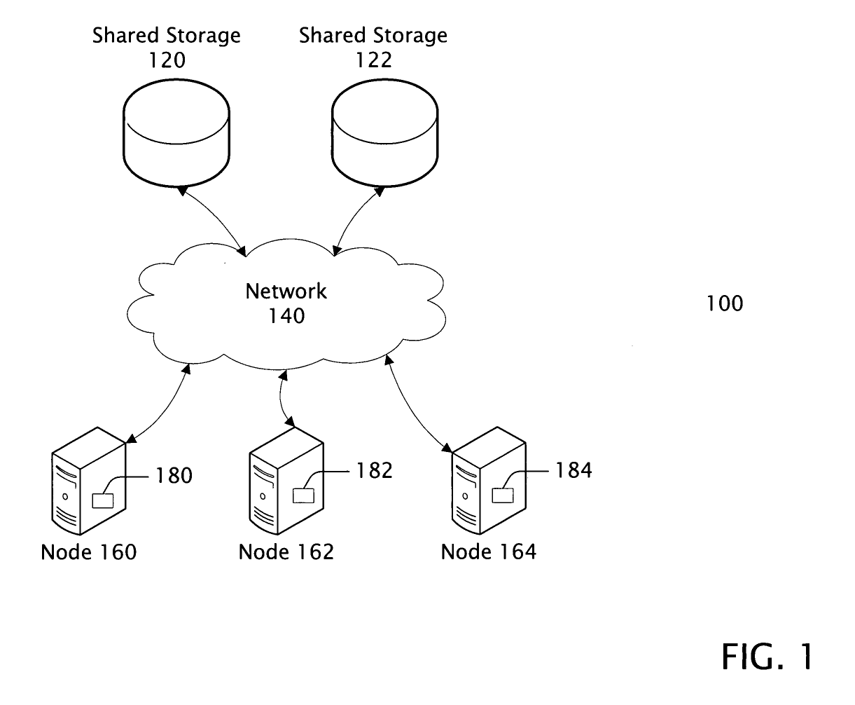

FIG. 1 is block diagram showing a distributed computing system 100 including several nodes and shared resources coupled by a network. Nodes 160, 162, and 164 are coupled to shared resources 120 and 122 via network 140. Other types of computing devices, peripheral devices, electronic apparatus or shared resources may be coupled to the system as well.

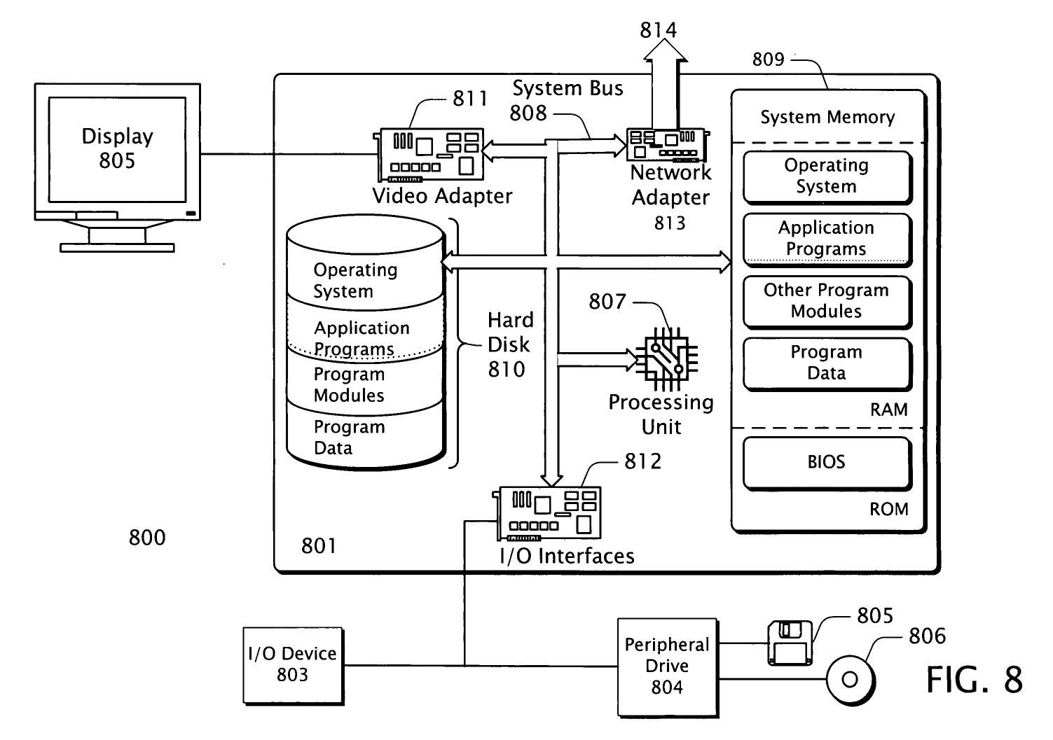

As used herein, the term node refers to any computer system, device, or process that is uniquely addressable, or otherwise uniquely identifiable, in a network (e.g., network 140) and that is operable to communicate with other nodes in the network. For example, and without limitation, a node may be a personal computer, a server computer, a hand-held or laptop device, a tablet device, a multiprocessor system, a microprocessor-based system, a set top box, a consumer electronic device, a network PC, a minicomputer, a mainframe computer, or the like. An example of a node 160, in the form of a computer system 800, is set forth below with respect to FIG. 8.

In one example, distributed system 100 may operate as a cluster with shared resources 120 and 122 coupled to nodes 160, 162, and 164 via network 140. Shared resources 120 and 122 may each be coupled to the network and nodes via an interface that supports reservation of shared resources 120 and 122 by nodes 160, 162, and 164, including the ability for a single node to reserve ownership of a shared resource. An example of such an interface is the small computer system interface (“SCSI”). Versions of the SCSI interface implement a registration and reservation command set making it possible for a node to register with a shared resource and reserve the shared resource, effectively taking ownership of the shared resource. Other types of interfaces may also be used to provide reservation functionality allowing a node to take ownership of the shared resource.

To reserve ownership of one type of shared resource, a reservation-enabled SCSI storage device for example, a node is typically required to register with the device using a unique reservation key. Once registered, the node may then reserve the device using its reservation key. If the device has already been reserved by another node (the device has a currently active reservation by another node), then a subsequent reservation attempt may fail. A currently active reservation may be preempted by another node, thus creating a new reservation of the device for the preempting node. To preempt a currently active reservation means that a node without the currently active reservation, say Node 2, takes ownership of the device from the node that has the currently active reservation, say Node 1. For example, assume that prior to preemption, Node 1 has the currently active reservation of a device. Node 1 is thus the owner of the device. If Node 2 successfully preempts Node 1's reservation then Node 2 becomes the new owner of the device and holds the currently active reservation.

Reservations may be persistent. That is, reservations may be persisted by the shared resource such that the reservations are retained by the shared resource even after the shared resource has been reset, stopped or shutdown, and restarted. A shared resource may only allow access to the node for which it is reserved, or it may allow access to any node that is registered, or to any node whether registered or not. Further, a reservation may provide exclusive access to the shared resource or only read and/or write access with read and/or write access being available only to the node holding the reservation or to any registered node. Other reservation variations may also be provided.

One example of the technology supports commands supported by a SCSI version 3 or greater (“SCSI-3”) device. Such a device tends to support the persistent reservation commands shown in Table 1. The following SCSI-3 commands are provided by way of example and not limitation. Any shared resource providing reservation functionality may be supported by the technology.

TABLE 1

| Command | Description |
|---|---|
| Register | Registers a node's reservation key with the device without |
| | creating a reservation. |
| Reserve | Creates a persistent reservation using a registered node's |
| | reservation key. |
| Release | Releases the requesting node's persistent reservation. |
| Clear | Clears all reservation keys and all persistent reservations. |
| Preempt | Preempts the currently active persistent reservation of a node |
| | using the node's reservation key, and removes the preempted |
| | node's registration. |
| Preempt & | Preempts the currently active persistent reservations of a node |
| Clear | using the node's reservation key, removes preempted node's |
| | registration and clears the task set for the preempted node. |
| Read Keys | Reads all reservation keys currently registered with the device. |
| Read | Reads all persistent reservations currently active on the |
| Reser- | device. |
| vations | |

Table 2 shows the types of persistent reservations that a SCSI-3 device may support.

TABLE 2

| Reser- | |
|---|---|
| vation | |
| Type | Description |
| Read | Reads Shared: Any node may read from the device. |
| Shared | Write Prohibited: No node may write to the device. |
| | Additional Reservations Allowed: Any registered node may |
| | place a reservation on the device so long as the new |
| | reservation does not conflict with any existing reservation. |
| Read | Reads Exclusive: Only the node holding the currently active |
| Exclusive | reservation may read from the device. |
| | Writes Shared: Any node may write to the device. |
| | Additional Reservations Allowed: Any registered node may |
| | place a reservation on the device so long as the new |
| | reservation does not conflict with any existing reservation. |
| Write | Reads Shared: Any node may read from the device. |
| Exclusive | Writes Exclusive: Only the node holding the currently active |
| | reservation may write to the device. |
| | Additional Reservations Allowed: Any registered node may |
| | place a reservation on the device so long as the new |
| | reservation does not conflict with any existing reservation. |
| Exclusive | Reads Exclusive: Only the node holding the currently active |
| Access | reservation may read from the device. |
| | Writes Exclusive: Only the node holding the currently active |
| | reservation may write to the device. |
| | Additional Reservations Restricted: Nodes other than the node |
| | with the currently active reservation may not place a |
| | reservation on the device. |
| Shared | Read Shared: Any node may read from the device. |
| Access | Write Shared: Any node may write to the device. |
| | Additional Reservations Restricted: Nodes other than the node |
| | with the currently active reservation may not place a |
| | reservation on the device. |

A node may execute such commands by submitting a command code to the device or by making a function call or the like. A node may be described as “registering a reservation key”, for example, when the node may actually submit an appropriate command code to a device or make an appropriate function call, providing the reservation key and/or any other data required. Such a command or call may result in instructions or the like being communicated to the device, or to a controller mechanism associated with the device, or the like, and the device or controller or some other mechanism performing the registration operation. Alternatively, such an operation may be carried out by other means.

Referring to FIG. 1, system 100 including may be, as an example, a clustering system. In starting such a cluster for the first time, typically no node yet owns shared resources 120 and 122. Each node 160, 162, and 164 in system 100 typically includes a cluster service, indicated by blocks 180, 182, and 184 respectively, generally a software component, that provides the cluster management functionality for the node and enables the reservation and maintenance of a shared resource. Other types of services or systems may also provide for the reservation and maintenance of a shared resource.

Each node's cluster service typically communicates via network 140 with the cluster services operating on the other nodes to perform cluster operations. Stating that a node “performs a cluster operation” generally indicates that the cluster service in conjunction with the node performs the operation. Stating that a cluster “performs an operation” generally indicates that the cluster services operating on the cluster nodes interact via their coupling regarding an operation, such operations typically being carried out by one or more of the cluster nodes. System 100 is not limited to being a clustering system and may be any type of distributed computing system. Services 180, 182, and 184 are not limited to being cluster services and may be any type of service capable of operating on a node.

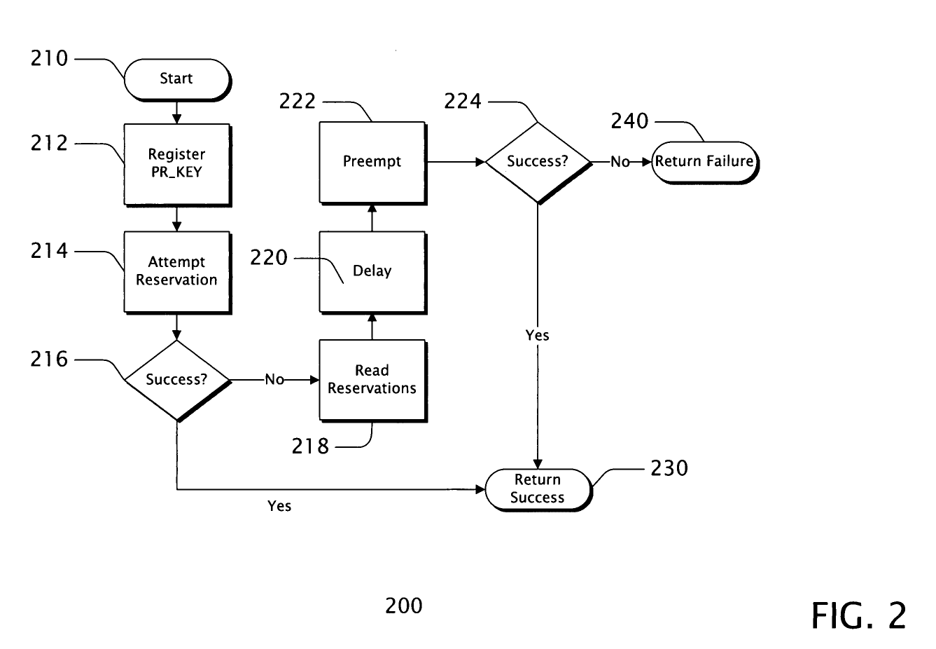

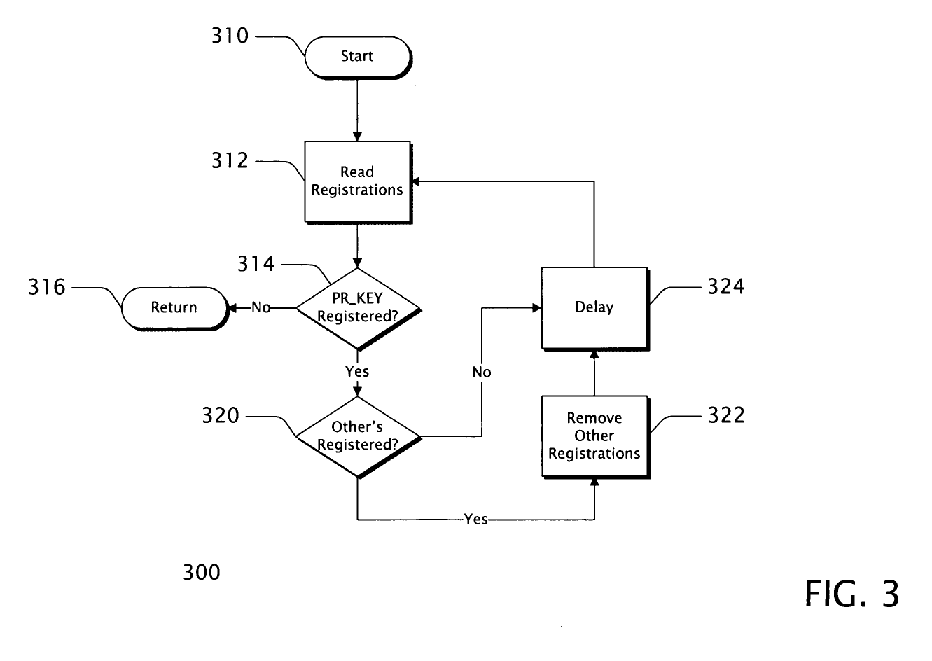

FIG. 2 and 3 illustrate processes including various steps that may be carried out in reserving and maintaining ownership of shared resources. The following descriptions of FIGS. 2 and 3 are made with reference to system 100 of FIG. 1. In particular, the descriptions of FIGS. 2 and 3 are made with reference to a node, such as node 160, 162, or 164, reserving and maintaining ownership of a shared resource, such as shared resource 120 or 122. However, it should be understood that the processes set forth in FIGS. 2 and 3 are not intended to be limited to being performed by any particular node or type of node, or in any particular distributed computing system or computing environment. The processes set forth in FIGS. 2 and 3, or any individual steps described in these process, may be implemented, in various other systems, including distributed systems. Additionally, it should be understood that while each of the processes illustrated in FIGS. 2 and 3 indicate a particular order of step execution, in other implementations the steps may be ordered differently. The process illustrated in FIGS. 2 and 3 may me implemented in accordance with the SCSI-3 standard or in accordance with various other command sets, interfaces, and/or protocols that have the basic functionality needed for reserving ownership of a shared resource.

FIG. 2 is a block diagram showing one example of an ownership reservation process 200 that a node may use to reserve ownership of a shared resource. Assuming node 160 is selected by the system 100 to attempt to take ownership of a shared resource 120, node 160 may use the process shown in FIG. 2 to reserve ownership of shared drive 120. The cluster service 180 operating on node 160 typically provides a unique reservation key, which is distinct from any other keys that may be used by any other nodes in the system.

At block 210, the cluster service 180 operating on reserving node 160 generally begins the process of taking ownership of shared resource 120.

At block 212, node 160 registers itself with the shared resource 120 using node 160's unique key. In one example this may be done using the SCSI-3 Register command or the like. Typically, once a node has been registered with a shared resource it may successfully attempt other operations on the shared resource; lack of registration generally results in failed operation attempts by an unregistered node.

At block 214, node 160 performs a reserve operation in an attempt to reserve shared resource 120 using node 160's unique key. In one example this may be done using the SCSI-3 Reserve command or the like.

At bock 216 a determination is made as to whether the attempted reservation 214 was successful. If reserve operation 214 was successful then success may be indicated (block 230) to cluster service 180 and reserving node 160 becomes the owner of shared resource 120. Node 160 may similarly use process 200 to take ownership of other shared resources, such as shared resource 122. If reserve operation 214 is not successful, then a pre-existing reservation may exist on shared resource 160 and process 200 continues at block 218.

At block 218, node 160 reads a pre-existing reservation on shared resource 160 and notes the pre-existing reservation key. Such a reservation may exist if node 162 or 164, for example, previously acquired ownership of shared resource 160. In one example reading reservations may be done using the SCSI-3 Read Reservations command or the like.

At block 220, node 160 delays process 200 for a brief period of time known as a reservation interval. In one example, reservation interval 220 may be approximately 6 seconds. The reservation interval delay tends to allow time for another node in the system that may be attempting to maintain a pre-existing ownership of shared resource 120, such as node 162 or 164, to perform ownership maintenance operations.

At block 222, node 160 attempts to preempt any pre-existing reservations read at 218 using node 160's own reservation key. Assuming reserving node 160 is still registered (no other node has subsequently cleared reserving node 160's registration 212), preemption attempt 222 typically succeeds. In one example this may be done using the SCSI-3 Preempt command or the like.

At block 224 a determination is made as to whether the attempted preemption 222 was successful. If the preemption 222 was successful then success may be indicated (block 230) to cluster service 180 and reserving node 160 becomes the owner of shared resource 120. If the preempt operation 222 is not successful, then process 200 continues at block 240.

At block 240, if preempt operation 222 failed then failure is indicated to cluster service 180 operating on node 160.

FIG. 3 is a block diagram showing one example of an ownership maintenance process 300 that a node may use to maintain ownership of a currently owned shared resource. Assuming node 160 currently owns shared resource 120, node 160 may use process 300 shown in FIG. 3 to maintain ownership of shared resource 120. Cluster service 180 operating on node 160 typically provides a unique reservation key which is distinct from any other keys that may be used by any other nodes in the system.

At block 310, maintaining node 160 has previously taken ownership of shared resource 120 and begins process 300 maintaining ownership of shared resource 120.

At block 312, node 160 reads a pre-existing reservation on shared resource 120 and notes the pre-existing reservation key. In one example this may be done using the SCSI-3 Read Reservations command or the like.

At block 314, if node 160's unique reservation key is not the pre-existing reservation key read at block 312, then process 300 returns (block 316) indicating to cluster service 180 that maintaining node 160 no longer owns shared resource 120. This may occur, for example, if node 160 failed while owning shared resource 120 and, node 160 coming back on-line at some later time found that another node, such as node 162 or 164, had since taken ownership of shared resource 120. Otherwise, if maintaining node 160's unique key is the pre-existing reservation key then maintaining node 160 is still be the owner of shared resource 120, and process 300 continues at block 320.

At block 320, if no reservation key other than node 160's reservation key was read at block 312, this indicates that no other nodes are attempting to take ownership of shared resource 120 and process 300 continues at block 324. If a reservation key other than node 160's reservation key was read at block 312 then process 300 continues at block 322.

At block 322, reservation keys other than maintaining node 160's unique reservation key are removed from shared resource 120. In one example this may be done using the SCSI-3 Preempt command or the like.

At block 324, node 160 delays process 300 for brief period of time known as a maintenance interval. In one example, maintenance interval 324 may be approximately 3 seconds. The maintenance interval 324 tends to be about half the length of reservation interval 220. Alternatively, intervals 220 and 324 may be other durations in length. Reservation interval 220 tends to be at least one-and-a-half times as long as maintenance interval 324. The maintenance interval delay of process 300 operating on node 160 tends to allow time for node 162 or 164 to attempt to obtain ownership of shared resource 120. The maintenance interval delay operation 324 may take place at the end of process 300, as shown in FIG. 3 or, alternatively, at the beginning of process 300 prior to read operation 312. Process 300 typically repeats at block 312.

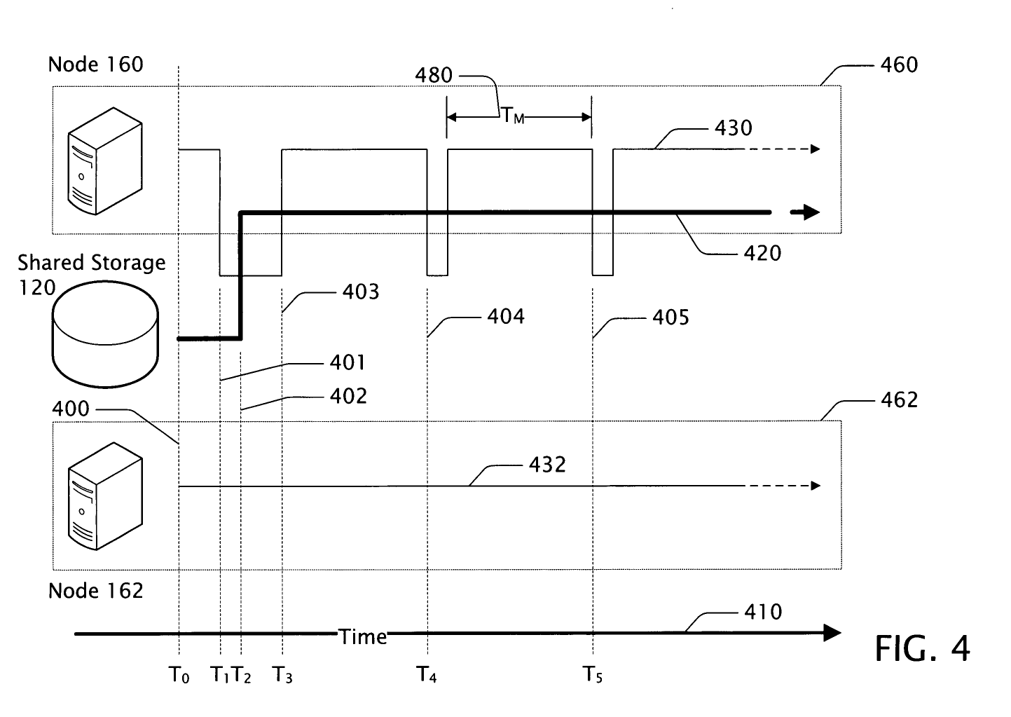

FIG. 4 is a timing diagram showing an example sequence for reserving and maintaining ownership of a shared resource. The example sequence shows only two nodes, nodes 160 and 162, along with a single shared resource, shared storage 120. In practice there may be more nodes and shared resources, but those shown are sufficient to illustrate an exemplary sequence. No specific duration for example sequence is implied by FIG. 4. Timeline 410 indicates the passage of time. Ownership boxes 460 and 462 indicate ownership by nodes 160 and 162 respectively of shared resource 120 ownership line 420 is shown inside one of the ownership boxes 460 and 462. The node activity lines 430 and 432 indicate specific activity of nodes 160 and 162 respectively in relationship to shared resource 120 as described below.

At 400, time T₀, the system comprising nodes 160 and 162 and shared resource 120, is shown beginning operation. At time T₀ share resource 120 is not yet owned by node 160 or 162 as shown by ownership line 420 at time T₀. At 401, time T₁, node 160 is shown beginning an ownership reservation process (FIG. 2, 200). During the reservation process node 160 is shown successfully obtaining ownership of shared resource 120, as indicated at 402, time T₂, by ownership line 420 transitioning inside node 160's ownership box 460. Thus, as of time T₂, shared resource 120 is shown as being owned by node 160. In this example, it is assumed that node 160 and node 162 are able to properly communicate. Node 160 is shown continuing to maintain ownership of shared resource 120. Node activity line 432 indicates that node 162 takes no action over time with respect to shared resource 120.

At 403, time T₃ indicates the completion of the reservation process. After ownership of shared resource 120 is obtained, node 160 typically begins an ownership maintenance process (FIG. 3, 300) relative to shared resource 120. At 404, time T₄ indicates the beginning of an ownership maintenance process as shown in FIG. 3. Typically this process will repeat at interval T_{M} (480) as long as node 160 owns shared resource 120. In one example, interval 480 is typically the maintenance interval described above (FIG. 3, 324).

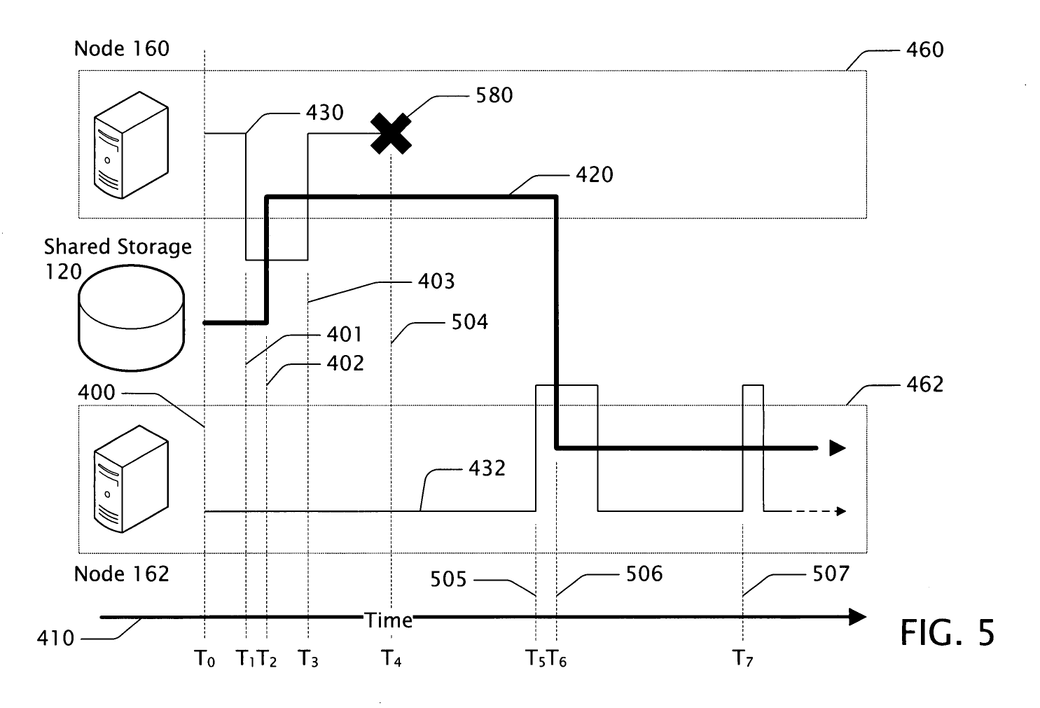

FIG. 5 is a timing diagram showing an example sequence for reserving and maintaining ownership of a shared resource when the node previously owning the shared resource fails. The example sequence starts out the same as shown in FIG. 4 until failure event 580 at 504, time T₄, indicating a failure of node 160. Possible failures may include failure of node 160 itself or failure of node 160's connectivity to shared resource 120, or the like. Such a failure is generally detected by the system and, in this example, node 162 is directed by the system to take ownership of shared resource 120 in place of failed node 160.

At 505, time T₅, node 162 is shown beginning a reservation process. In one example, as described for the reservation process shown in FIG. 2, node 162 may preempt ownership of shared resource 120 from failed node 160. The reservation process may include waiting the reservation interval as shown in FIG. 2, a delay not shown in FIG. 5. During the reservation process node 162 is shown successfully reserving ownership of shared resource 120, as indicated at 506, time T₆ by device ownership line 420 transitioning inside node 162's ownership box 562. Thus, as of time T₆, shared resource 120 is shown as being owned by node 162 instead of failed node 160. After ownership of shared resource 120 is obtained, node 162 typically begins an ownership maintenance process relative to the owned shared resource. Line 507, time T₇, indicates the beginning of an ownership maintenance process. Typically this process will repeat as described for FIG. 3.

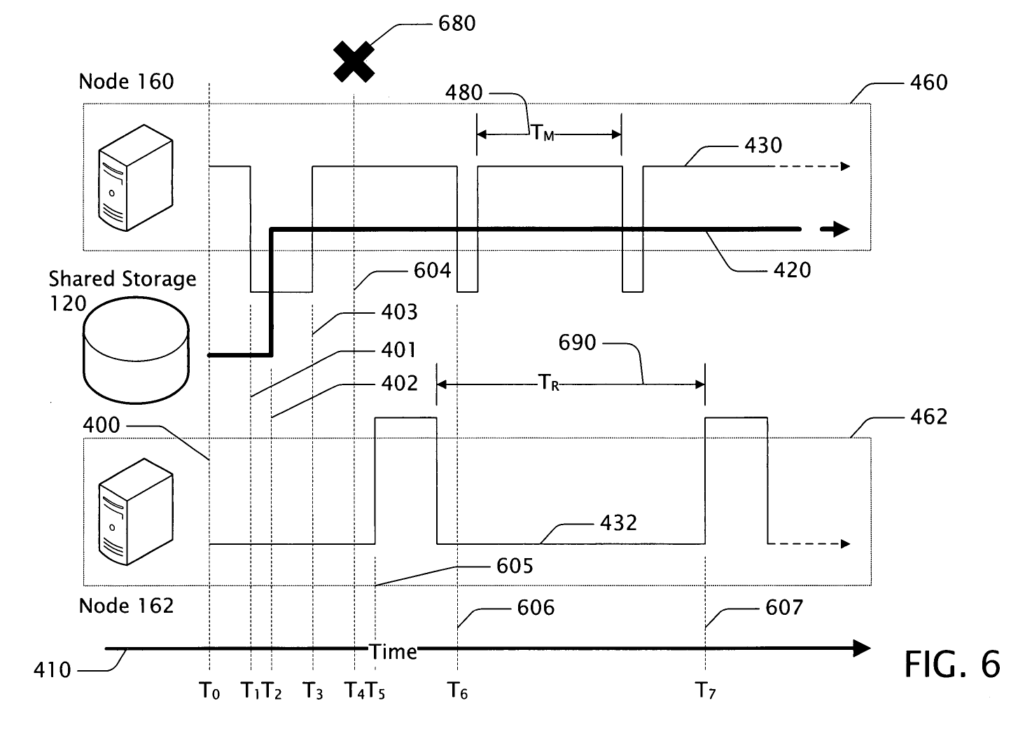

FIG. 6 is a timing diagram showing an example sequence for reserving and maintaining ownership of a shared resource after communications between nodes fails. The example sequence starts out the same as shown in FIG. 4 until the occurrence of failure event 680 at 604, time T₄, indicating failure of communications between nodes 160 and 162. In this example, both nodes 160 and 162 may still be able to communicate with shared resource 120, but nodes 160 and 162 have lost communications with each other. Possible failures may include network failures or failure of a node's connectivity to the communications network, or the like. Such a failure is generally detected by the cluster service operating on each node. In this example, even though node 160 remains operational with proper ownership of shared resource 120, node 162 may be directed to attempt to take ownership of shared resource 120 by its cluster service as node 162 is incapable of detecting that node 160 is still operational due to communications failure 680.

At line 605, time T₅, node 162 is shown by activity line 432 beginning a reservation process. In one example, as described for the reservation process shown in FIG. 2, node 162 is unsuccessful in an attempted reservation (FIG. 2, blocks 214 & 216) because node 160 continues to actively maintain its reservation. After failing the reservation attempt, node 162 delays the reservation process for interval T_{R} (690 and FIG. 2, block 220) before attempting to preempt ownership of shared resource 120 from node 160. Interval 690 is typically the reservation interval shown in FIG. 2, 200.

During node 162's delay of interval T_{R} (690) node 160 typically repeats its ownership maintenance process, as shown at at line 606, time T₆. During the ownership maintenance process, as shown in FIG. 3, node 160 typically reads registrations registered on shared resource 120 and, as node 160 is still the owner, removes registrations other than its own (FIG. 3, blocks 312-322). Then, node 162, after its delay interval at line 607, time T₇, attempts to preempt ownership of shared resource 120 from node 160 (FIG. 2, block 222). But, because node 160 previously cleared node 162's registration from shared resource 120 during delay interval T_{R} (690) via node 160's maintenance process shown by activity line 430 at approximately time T₆ (606), node 162's preempt attempt fails as node 162 is no longer registered with shared resource 120. Thus node 160 retains ownership of shared resource 120 even though communications have failed between the nodes and node 162 attempts to take ownership of shared resource 120.

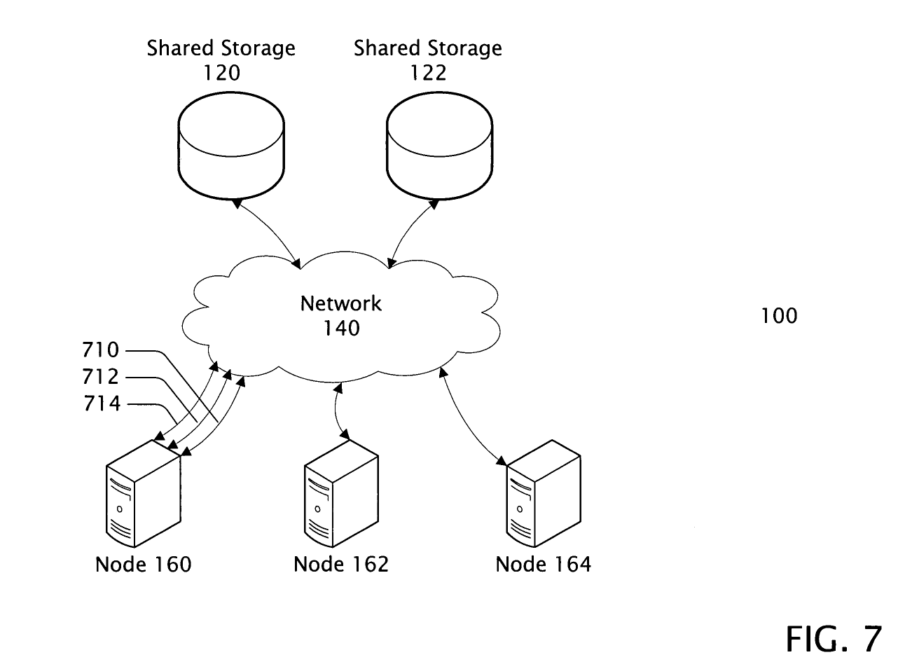

FIG. 7 is a block diagram showing a distributed computing system 100 including a node 160 with multiple device interfaces. System 100 is similar to that of FIG. 1 except node 160 is shown with three example device interfaces 710, 712, and 714, although any number of device interfaces may be used. In one example, the device interfaces may be SCSI interface cards providing redundant connectivity to shared resources 120 and/or 122. Any number of redundant interfaces may be provided and may allow node 160 to communicate with one or more shared resources.

In one example, node 160 may register with a shared resource one time for each redundant interface 710, 712, and 714. Such registrations typically include a unique reservation key for node 160 and a unique identification (“ID”) for each of the redundant interfaces 710, 712, and 714. Thus node 160 is registered with shared resource 120 once for each redundant interface 710, 712, and 714, each registration including node 160's unique reservation key and the unique ID for each one of redundant interfaces 710, 712, and 714. In this manner, a node may register itself multiple times with a shared resource, reserve the shared resource and communicate with the shared resource over multiple redundant interfaces.

FIG. 8 is a block diagram showing an example computing environment 800 in which the technology described above may be implemented. Nodes 160, 162, and 164 as shown in the earlier figures may be similar to computing environment 800. Computing environment 800 is only one example of a computing system or device that may operate as a node and is not intended to limit the examples described in this application to this particular computing environment or device type.

A suitable computing environment may be implemented with numerous other general purpose or special purpose systems. Examples of well known systems may include, but are not limited to, personal computers (“PC”), hand-held or laptop devices, microprocessor-based systems, multiprocessor systems, servers, and the like.

PC 800 includes a general-purpose computing system in the form of computing device 801 coupled to various peripheral devices 803, 804, 805 and the like. System 800 may couple to various input devices 803, including keyboards and pointing devices such as a mouse via one or more I/O interfaces 812. The system 800 may be implemented on a conventional PC, server, workstation, laptop, hand-held device, consumer electronic device, or the like. The components of computing device 801 may include one or more processors (including central processing units (“CPU”), graphics processing units (“GPU”), microprocessors, and the like) 807, system memory 809, and a system bus 808 that couples the various system components. Processor 807 processes various computer-executable instructions to control the operation of computing device 801 and to communicate with other electronic and/or computing devices (not shown) via various communications connections such as a network connection 814 and the like. System bus 808 represents any number of several types of bus structures, including a memory bus or memory controller, a peripheral bus, a serial bus, an accelerated graphics port, and/or a processor or local bus using any of a variety of bus architectures.

System memory 809 may include computer readable media in the form of volatile memory, such as random access memory (“RAM”), and/or non-volatile memory, such as read only memory (“ROM”). A basic input/output system (“BIOS”) may be stored in ROM or the like. System memory 809 typically contains data, computer-executable instructions and/or program modules that are immediately accessible to and/or presently operated on by one or more of the processors 807.

Mass storage devices 804 and 810 may be coupled to computing device 801 or incorporated into computing device 801 by coupling to the system bus. Such mass storage devices 804 and 810 may include a magnetic disk drive which reads from and writes to a removable, non volatile magnetic disk (e.g., a “floppy disk”) 805, and/or an optical disk drive that reads from and/or writes to a non-volatile optical disk such as a CD ROM, DVD ROM or the like 806. Other mass storage devices include memory cards, memory sticks, tape storage devices, and the like. Computer-readable media 805 and 806 typically embody computer readable instructions, data structures, program modules, files and the like supplied on floppy disks, CDs, DVDs, portable memory sticks and the like. Computer-readable media typically includes mass storage devices, portable storage devices and system memory.

Any number of program programs, files or modules may be stored on the hard disk 810, other mass storage devices 804, and system memory 809 (typically limited by available space) including, by way of example, an operating system(s), one or more application programs, files, other program modules, and/or program data. Each of such operating system, application program, file, other program modules and program data (or some combination thereof) may include an example of the systems and methods described herein.

A display device 805 may be coupled to the system bus 808 via an interface, such as a video adapter 811. A user may interface with computing device 800 via any number of different input devices 803 such as a keyboard, pointing device, joystick, game pad, serial port, and the like. These and other input devices may be coupled to the processors 807 via input/output interfaces 812 that may be coupled to the system bus 808, and may be coupled by other interface and bus structures, such as a parallel port, game port, universal serial bus (“USB”), and the like.

Computing device 800 may operate in a networked environment using communications connections to one or more remote nodes and/or devices through one or more local area networks (“LAN”), wide area networks (“WAN”), storage area networks (“SAN”), the Internet, radio links, optical links and the like. Computing device 800 may be coupled to a network via network adapter 813 or alternatively via a modem, DSL, ISDN interface or the like.

Communications connection 814 is an example of communications media. Communications media typically embody computer readable instructions, data structures, files, program modules and/or other data using a modulated data signal such as a carrier wave or other transport mechanism and includes any information delivery media. The term “modulated data signal” typically means a signal that has one or more of its characteristics set or changed in such a manner as to encode information in the signal. By way of example, and not limitation, communications media may include wired media such as a wired network or direct-wired connection or the like, and/or wireless media such as acoustic, radio frequency, infrared, and other wireless media.

Storage devices utilized to store computer-readable and/or -executable instructions can be distributed across a network. For example, a remote computer or storage device may store an example of the system described above as software. A local or terminal computer or node may access the remote computer or storage device and download a part or all of the software and may execute any computer-executable instructions. Alternatively the local computer may download pieces of the software as needed, or distributively process the software by executing some of the software instructions at the local terminal and some at remote computers and/or devices.

By utilizing conventional techniques that all, or a portion, of the software instructions may be carried out by a dedicated electronic circuit such as a digital signal processor (“DSP”), programmable logic array (“PLA”), discrete circuits, and the like. The term “electronic apparatus” as used herein may include computing devices and consumer electronic devices comprising any software, firmware or the like, and electronic devices or circuits comprising no software, firmware or the like.

The term “computer-readable medium” may include system memory, hard disks, mass storage devices and their associated media, communications media, and the like.

1. In a distributed computing system, a method for a node to reserve ownership of a shared resource, the method comprising:
registering the node with the shared resource at a time t1 using a first registration; and
attempting to detect the first registration with the shared resource at a time t2 and, if the first registration is detected, preempting a pre-existing reservation placing a new reservation for the node with the shared resource at a time t3, the new reservation limiting any other node from reserving ownership of the shared resource.

2. The method of claim 1, further comprising delaying a first interval of time between registering the node at the time t1 and preempting a pre-existing reservation placing a new reservation for the node with the shared resource at the time t3, the first interval of time being a reservation interval.

3. The method of claim 1, further comprising:
after placing the new reservation with the shared resource at the time t3, attempting to detect a second registration; and
at a time t4, if the second registration is detected, removing the second registration;

4. The method of claim 3, further comprising, after the time t4, delaying a second interval of time and then repeating the method of claim 2, the second interval of time being a maintenance interval.

5. The method of claim 1, wherein the shared resource includes a small computer system interface and a registration and reservation mechanism.

6. The method of claim 1, wherein the node is coupled to the shared resource via a network.

7. The method of claim 6, wherein the network includes a storage area network.

8. The method of claim 1, wherein the first registration includes one or more reservation keys, each reservation key being related to one interface device of one or more interface devices for accessing the shared resource.

9. The method of claim 8, wherein the new reservation enables access to the shared resource via the one or more interface devices.

10. The method of claim 1, wherein computer-executable instructions for performing the method of claim 1 are stored on a computer-readable medium.

11. The method of claim 1, wherein, after the node reserving ownership of the shared resource experiences a failure condition and a second node coupled to the shared resource reserves ownership of the shared resource.

12. The method of claim 1, wherein the first registration does not delay operation of the shared resource.

13. A system for reserving ownership of a shared resource, the system comprising:
a coupling between a node and the shared resource; and
a first registration being registered for the node with the shared resource at a time t1 by the system; the system attempting to detect the first registration with the shared resource at a time t2 and, if the first registration is detected, preempting a pre-existing reservation placing a new reservation for the node with the shared resource at a time t3, the new reservation limiting any other nodes from reserving ownership of the shared resource.

14. The system of claim 13, wherein the system waits a first time interval between the first registration being registered for the node at the time t1 and preempting a pre-existing reservation placing a new reservation for the node with the shared resource at the time t3, the first interval of time being a reservation interval.

15. The system of claim 13, wherein, after placing the new reservation with the shared resource at time t3, the system attempts to detect a second registration and, at a time t4, if the second registration is detected, removes the second registration;

16. The system of claim 15, wherein, after the time t4, the system delays a second time interval and then repeats the detection and removal of the second registration, the second interval of time being a maintenance interval.

17. The system of claim 13, wherein the first registration includes a plurality of reservation keys, each reservation key being related to one interface device of one or more interface devices for accessing the shared resource.

18. The system of claim 17, wherein the new reservation enables access to the shared resource via the one or more interface devices.

19. A computer-readable medium, embodying computer-executable instructions for performing a method to reserve ownership of a shared resource, the method comprising:
registering a node with the shared resource using a first registration;
attempting to reserve ownership of the shared resource for the node; and
if unable to reserve ownership of the shared resource:
attempting to detect a pre-existing reservation with the shared resource,
delaying a first interval of time, the first interval of time being a reservation interval, and
preempting the pre-existing reservation placing a new reservation for the node with the shared resource, the new reservation limiting any other node from reserving ownership of the shared resource.

20. The computer-readable medium of claim 19, wherein the method further comprises:
reading any registrations with the shared resource;
attempting to detect the first registration with the shared resource; and
if the first registration is detected:
removing the any registrations except the first registration with the shared resource,
delaying a second interval of time, the second interval of time being a maintenance interval, and
repeating the method of claim 20.
